(19) United States
(12) Patent Application Publication
(10) Pub. No.: US 2020/0042152 A1
(43) Pub. Date: Feb. 6, 2020

(54) Photographing Method and Mobile Terminal Using Same

(71) Applicant: AAC Technologies Pte. Ltd., Singapore city (SG)

(72) Inventor: Yulei Zhang, Shenzhen (CN)

(21) Appl. No.: 16/528,632

(22) Filed: Aug. 1, 2019

(30) Foreign Application Priority Data
Aug. 4, 2018 (CN) 201810880520.4

(51) Int. Cl. G06F 3/041; G06F 3/01; G06F 3/0489; G06F 3/0481; H04M 1/725

(52) U.S. Cl. CPC G06F 3/04146; G06F 3/016; G06F 3/04895; G06F 2203/04806; H04M 1/7258; G06F 2203/04105; G06F 3/0481

(57) ABSTRACT

The present disclosure provides a photographing method used in a mobile terminal including a side provided with a pressure sensing area, including the steps of: detecting an operation status of a camera of the mobile terminal, when the camera is activated, obtaining a pressure value of the pressure sensing area; comparing the pressure value to a first predetermined threshold value, when the pressure value achieves the first threshold value, controlling the camera to photograph. The shutter key in the related art is displaced by the pressure sensing area, the occupation of such a key is reduced, and an effective displaying area is increased, which is so much convenient for a user to photograph.

### FIELD OF THE PRESENT DISCLOSURE

The embodiment of the present disclosure relates to the field of photographing technologies, and more particularly to a photographing method and a mobile terminal using the method.

### DESCRIPTION OF RELATED ART

As the human-computer interaction devices, touch devices are widely used in various mobile terminals, such as smart phones, tablets, etc. A mobile terminal is now not only a communication tool, but also a tool for interacting with friends and entertainment. More and more functions are equipped with the mobile terminals, such as, videos, games, music playback. Besides, photographing is a key function concerned by more and more users.

The inventor of the present invention finds that the shutter key for shooting images or videos will occupy a certain area of the screen. The shutting key is formed on the display area of the screen, or is physically arranged near the screen, whichever will decrease the effective displaying area of the screen. The decrease of the screen will directly cause the decrease of viewing frame, which causes bad user experience.

Therefore, it is desired to get an improved photographing method to solve the mentions mentioned above.

### BRIEF DESCRIPTION OF THE DRAWINGS

Many aspects of the exemplary embodiments can be better understood with reference to the following drawings. The components in the drawing are not necessarily drawn to scale, the emphasis instead being placed upon clearly illustrating the principles of the present disclosure.

FIG. 1 is a flow chart of a photographing method in accordance with a first embodiment of the present disclosure.

FIG. 2 is a flow chart of a photographing method in accordance with a second embodiment of the present disclosure.

FIG. 3 is an illustration of operation of the photographing method of the second exemplary embodiment.

FIG. 4 is a flow chart of a photographing method in accordance with a third embodiment of the present disclosure.

FIG. 5 is an illustration of a mobile terminal using the photographing method, in accordance with a fourth embodiment of the present disclosure.

### DETAILED DESCRIPTION OF THE EXEMPLARY EMBODIMENTS

The present disclosure will hereinafter be described in detail with reference to exemplary embodiments. To make the technical problems to be solved, technical solutions and beneficial effects of the present disclosure more apparent, the present disclosure is described in further detail together with the figures and the embodiments. It should be understood the specific embodiment described hereby are only to explain the disclosure, not intended to limit the disclosure.

A first embodiment of the present disclosure relates to a photographing method capable being used in a mobile terminal. The mobile terminal may be a mobile phone, a tablet. The mobile terminal will be taken as an example to explain the present disclosure. In a mobile phone, the shutter key is either an icon displayed on the screen, either a physical key adjacent to the screen. As a result, a certain area occupied by the shutter key will decrease the effective displaying area of the screen. And, the shutter key (either icon or physical key) is not convenient to be operated by the user. Accordingly, user experiences are badly affected.

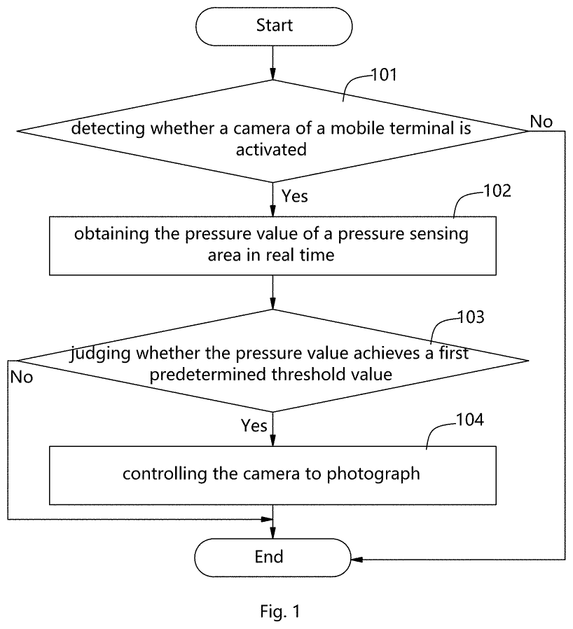

A photographing method of a first embodiment is shown in FIG. 1. The method includes the steps of:

Step 101: detecting an operation status of a camera of the mobile terminal; when the operation status is “on”, go step 102, otherwise end the step.

Specifically, a pressure sensing area is formed at a side (i.e., a surface perpendicular to the screen) of the mobile phone for obtaining the pressure value applied by the user to the area. When the operation status of the camera is detected “on”, the pressure value is obtained. This is a very important feature that first detect the operation status of the camera before obtaining the pressure value, which avoids the pressure sensing area form being always working, and avoids un-necessary power loss, in the case that the user hold the side of the mobile terminal but not willing to photograph. When the camera is not working (off), no operation will be triggered, even if the pressure sensing area is pressed. But the working status of the camera will trigger the step of obtaining the pressure value of the pressure sensing area.

Step 102: Obtaining the pressure value of the pressure sensing area.

Specifically, the screens of mobile terminals include curved screens and non-curved screens. For a curved screen, the side is used as a part of the displaying area. And for a non-curved screen, the side is a middle frame without the displaying function. The pressure sensing area of the embodiment may be disposed at the side of a non-curved screen, or inside the side of the curved screen. The pressure sensing area can be performed by hardware. For example, the side is provided with one or more pressure modules. The pressure sensing area is defined to include all positions where the pressure sensing locates. And the pressure values of all the positions can be measured and obtained. Of course, it is also feasible that only some selected positions of the side are equipped with pressure sensing area. The selected positions are the positions where the user usually uses. Besides hardware, other means like software, combination of hardware and software are also feasible. In the embodiment, the pressure value will be obtained only after the camera is detected “on”, for detecting whether the user is operating the pressure sensing area.

Step 103: judging whether the pressure value is greater than a first predetermined threshold value. If yes, go step 104, otherwise end the method.

Specifically, when the pressure value is obtained after the camera is detected “on”, it means the corresponding area is operated by the user. Compare the pressure value with the first predetermined threshold value, and if the pressure value is equal to or greater than the first threshold value, control the camera to photograph an image. If the pressure value is less than the first predetermined threshold value, end the step. The first threshold value is a value order the camera to shoot. The first threshold value can be adjusted by the user according the user's custom. It is suggested that the threshold value is adjusted according to an operation force the user uses to proceed normal operations. The first threshold value can be a little greater than that force. The user will not misoperate the camera because the threshold value is not satisfied. It should be noted that each time the pressure value is obtained in Step 102, step 103 should be repeated.

Step 104: Control the camera to shoot (photograph a photo).

Specifically, when the pressure value is obtained and is judged greater than the first threshold value, it means that the user operates the side and the camera is controlled to shoot an image. The shutter key in the related art is displaced by the pressure sensing area, the occupation of such a key is reduced, and an effective displaying area is increased, which is so much convenient for a user to photograph. When the camera of the mobile terminal woks at a “photo mode”, the camera is controlled to take a picture by the method mentioned above. When the camera of the mobile terminal works at “video” mode, the camera is controlled to take a video.

Compared with related art, the present disclosure provide a photographing method used in a mobile terminal. A side of the mobile terminal is provided with pressure sensing areas, and when the pressure value of the pressure sensing area is obtained after the camera is detected “on”. When the pressure value of the pressure sensing area is greater than the first predetermined threshold value, the camera is controlled to shoot an image or a video. The shutter key in the related art is displaced by the pressure sensing area, the occupation of such a key is reduced, and an effective displaying area is increased, which is so much convenient for a user to photograph.

A second embodiment of the present disclosure is an improvement of the first embodiment. The major improvement is that a second predetermined threshold value is defined, and the second predetermined threshold value is smaller than the first predetermined threshold value. When the pressure value of the pressure sensing area is obtained, the pressure value is compared with the second predetermined threshold value. If the pressure value is equal to or greater than the second predetermined threshold value, auto-focusing function is performed. Generally, the auto-focusing function is performed by an auto-focusing module. The second predetermined threshold value is smaller than the first predetermined threshold value.

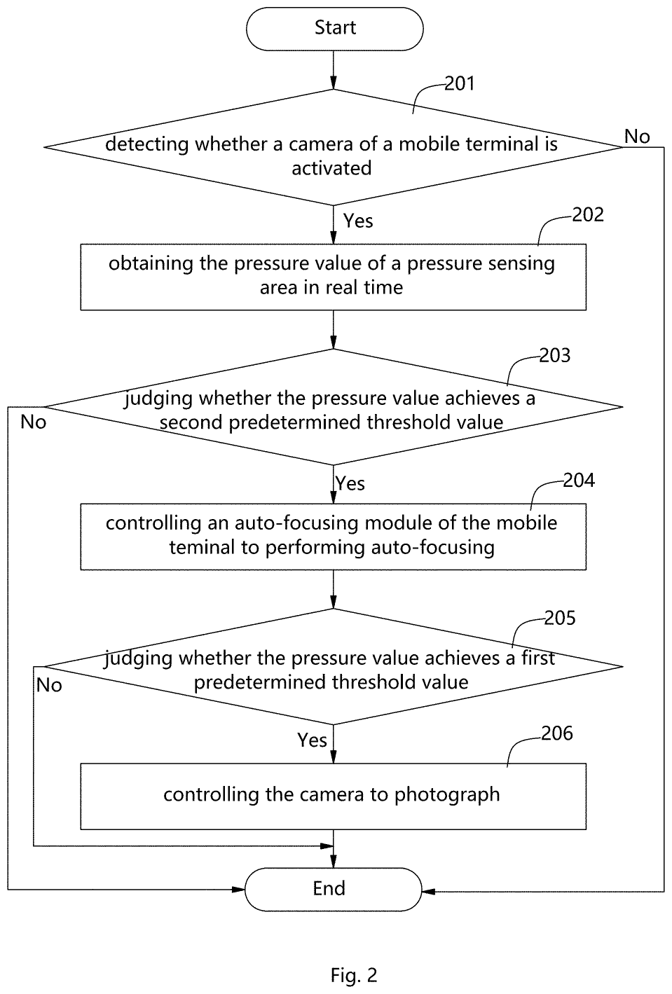

The method of the second embodiment is shown in FIG. 2. The method includes the steps of:

Step 201: detecting an operation status of a camera of the mobile terminal; when the operation status is “on”, go step 202, otherwise end the step.

Step 202: Obtaining the pressure value of the pressure sensing area.

Specifically, the screens of mobile terminals include curved screens and non-curved screens. For a curved screen, the side is used as a part of the displaying area. And for a non-curved screen, the side is a middle frame without the displaying function. The pressure sensing area of the embodiment may be disposed at the side of a non-curved screen, or inside the side of the curved screen. The pressure sensing area can be performed by hardware. For example, the side is provided with one or more pressure modules. The pressure sensing area is defined to include all positions where the pressure sensing locates. And the pressure values of all the positions can be measured and obtained. Of course, it is also feasible that only some selected positions of the side are equipped with pressure sensing area. The selected positions are the positions where the user usually uses. Besides hardware, other means like software, combination of hardware and software are also feasible. In the embodiment, the pressure value will be obtained only after the camera is detected “on”, for detecting whether the user is operating the pressure sensing area.

Step 203: judging whether the pressure value is greater than a second predetermined threshold value. If yes, go step 204, otherwise end the method.

Specifically, the second predetermined threshold value is smaller than the first threshold value. When the pressure value is obtained after the camera is detected “on”, it means the corresponding area is operated by the user. Compare the pressure value with the second predetermined threshold value, and if the pressure value is equal to or greater than the second threshold value, control the camera to proceed “auto-focusing”. If the pressure value is less than the first predetermined threshold value, end the step. Because the second predetermined threshold value is smaller than the first predetermined threshold value, the pressure value must first satisfy the second predetermined threshold value and then satisfy the first predetermined threshold value. By the embodiment, the auto-focusing function is performed by the pressure sensing area and ensure that the picture obtained by the mobile terminal is clear. In the embodiment, the second threshold value means a value indicating that the auto-focusing process should be first performed. The second predetermined threshold value is also self-defined by the user, as long as the second predetermined threshold value is smaller than the first predetermined threshold value. It should be noted that each time the pressure value is obtained in Step 202, step 203 should be repeated.

Step 204: Controlling the auto-focusing module of the camera to perform auto-focusing function.

Specifically, when the pressure value obtained from the pressure sensing area is equal to or greater than the second predetermined threshold value, it is convenient for the user to perform auto-focusing process by pressing the side of the mobile terminal. The force (the pressure) is gradually increased from the second predetermined threshold value to the first predetermined threshold value, therefore, when the auto-focusing function is completed, the operation of “photographing a photo” is triggered when the first predetermined threshold value is also satisfied. The embodiment can also use another method to trigger “auto-focusing” function, other than define a second predetermined threshold value, i.e., two quick taps in a short time will also trigger auto-focusing function. However, such a way will make the mobile terminal shake, which will affect the image quality.

Step 205: judging whether the pressure value is greater than a first predetermined threshold value. If yes, go step 206, otherwise end the method.

Step 206: Controlling the camera to photograph.

The contents of the step 205, step 206 are substantially identical to steps 103, 104.

Further, when the pressure value of the pressure sensing area is obtained, an additional step is included: when the pressure value achieve the first or second predetermined threshold values, produce tactile feedback to remind the user that the operation is correct.

More specifically, when the pressure value of the pressure sensing area achieves the predetermined threshold value, produce tactile feedback to the user for indicating that the present operation is correct, which makes the user understand whether the operation is correct or not, and further reminds the user to adjust the operation to an accurate one. In the embodiment, the way to produce the tactile feedback is to arrange micro-vibrators in the pressure sensing area. The micro-vibrator here is used to provide micro-vibration to the user.

In addition, the photographing method includes the step of detecting the sliding operation on the pressure sensing area. According to a direction of the sliding operation, a focal length of the camera is adjusted.

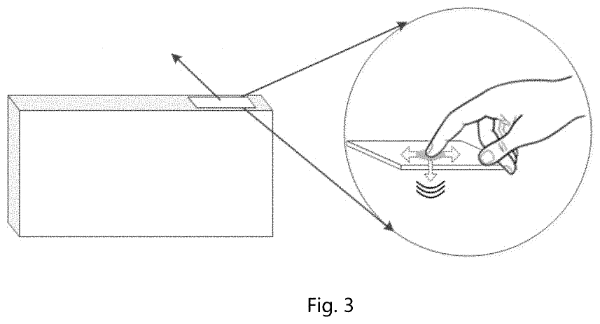

Referring to FIG. 3, FIG. 3 is an illustration of such a photographing method. The user slides the finger on the pressure sensing area 1, and the direction of the slide reflects the increase or decrease of the focal length, which performs the variable focal length (zoom function). It is so much convenient for the user to operate the camera. For example, when the user slides upwardly, the operation is defined to increase the focal length; when the user slides downwardly, the operation is defined to decrease the focal length. Or, when the user slides towards the left, the operation is defined to increase the focal length; when the user slides towards the right, the operation is defined to decrease the focal length. Generally, the side of a mobile terminal is a strip-like component, so, it is preferred to use the slide along an upward-downward direction to reflect the adjustment of focal length. As an improvement, when the screen is a curved one, i.e., the side is also a display area, a dot displayed on the side can be configured to indicate the position of the user's finger, by which the user can directly watch the operation and judge whether the operation is correct or not. The user's experience is further improved.

Compared with the related art, the present disclosure provides a photographing method using the pressure value of the pressure sensing area and judging whether the pressure value achieves or not the second predetermined threshold value. When the pressure value achieves the second predetermined threshold value, the auto-focusing module is activated to perform auto-focusing function. By virtue of the pressure value, the shake of the camera produced by other operation is depressed, and the user's experience is improved. In addition, when the pressure value of the pressure sensing area achieves the predetermined threshold value, produce tactile feedback to the user for indicating that the present operation is correct, which makes the user understand whether the operation is correct or not, and further reminds the user to adjust the operation to an accurate one. Furthermore, when the user slides the finger on the pressure sensing area, the direction of the slide reflects the increase or decrease of the focal length, which performs the variable focal length (zoom function). It is so much convenient for the user to operate the camera.

A third embodiment of the present disclosure is an improvement of the first embodiment. The improvement is, before obtaining the pressure value of the pressure sensing area, detecting whether the screen of the mobile terminal is at landscape status. If the screen is at landscape status, the step of obtaining the pressure value is performed.

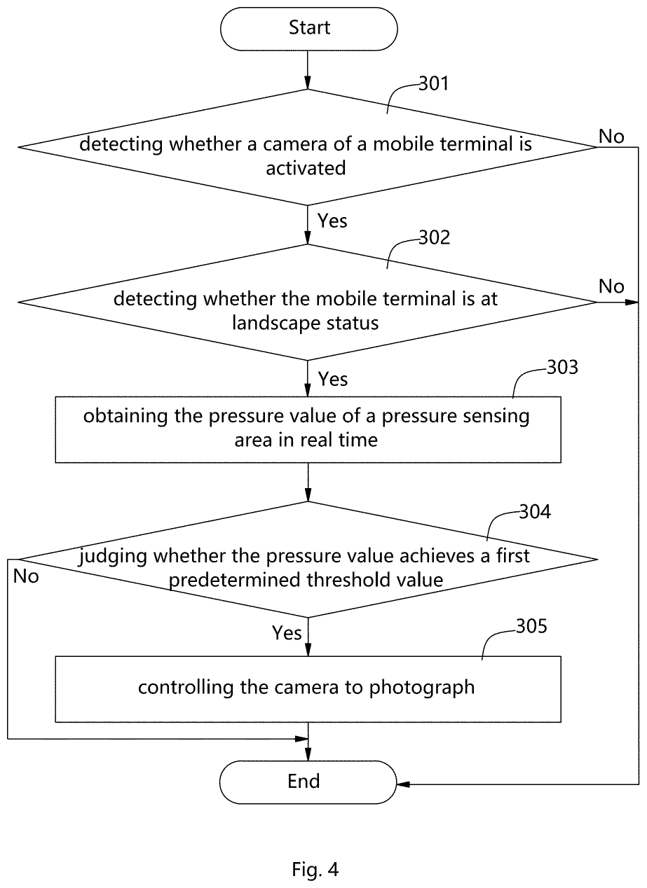

A flow chart of the method of the third embodiment is shown in FIG. 4. The method includes the steps of:

Step 301: detecting an operation status of a camera of the mobile terminal; when the operation status is “on”, go step 302, otherwise end the step.

Step 302: detecting whether the screen is at landscape status. If yes, go step 303, otherwise end the step.

Specifically, by detecting whether the screen is at landscape status or not, determine whether the side of the screen should be activated to an effective area (virtual shutter key) to operate the camera. When the screen is at landscape status, the pressure sensing area is activated and obtain the pressure value in real time. When a user operate a mobile terminal at a landscape status, the position where the user holds the mobile terminal is generally the lower side. Thus, when the mobile terminal is at landscape status, the pressure sensing area is activated, which satisfies the user's operation custom. When detecting that the screen is not at landscape status, end the step. When the screen is not at landscape status, the user can operate the shutter key provided by the mobile terminal or by a specific application. In actual case, when the screen is at portrait status, the shutter key provided by the mobile terminal can be remained or even cancelled. The user can operate the camera only by operate the pressure sensing area. When the screen is shifted from the portrait status to the landscape status, the shutter key can be cancelled or minimized to enlarge the effective displaying area and the viewing area, which satisfies the user's custom better.

Step 303: obtaining the pressure value of the pressure sensing value.

Step 304: Judging whether the pressure value achieves the first predetermined threshold value, if yes, go step 305, otherwise end the step.

Step 305: controlling the camera to photograph a photo.

The steps 303˜305 are substantially identical to the steps 102˜104. Therefore. The steps 303˜305 will not be described in detail.

In addition, when detecting that the screen is at landscape status, provide the user with a reminder that the user can operate the camera by operating on the side. When the user operate the mobile terminal at landscape status, a reminder is provided to remind the user to photograph photos by operating the side of the mobile terminal. The reminder may be achieved by an animation, a voice prompt, or text prompt. Of course, when the user operate the mobile terminal at the first time, such a remainder can be presented to the user for making it convenient to use the mobile terminal.

Compared to the related art, when a user operate a mobile terminal at a landscape status, the position where the user holds the mobile terminal is generally the lower side. Thus, when the mobile terminal is at landscape status, the pressure sensing area is activated, which satisfies the user's operation custom. When detecting that the screen is not at landscape status, end the step.

The method provided by the present disclosure is described in the form of several steps, which is beneficial to understand the content of the method. In actual application, some of the steps can be merged into one step, or one of the steps can be split into several steps. As long as the steps contain the same logic, the method is protected by the present disclosure. Inessential amendment or configurations without essential modifications will not affect the protection core of the present disclosure.

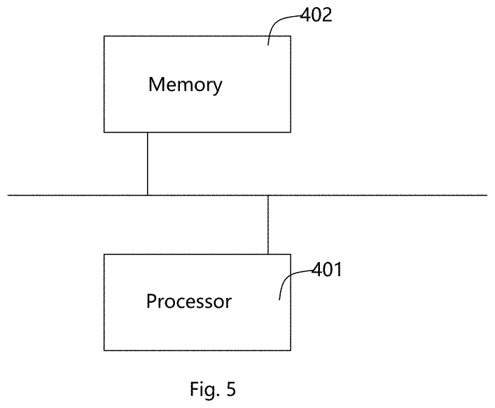

A fourth embodiment of the present disclosure relates to a mobile terminal, as shown in FIG. 5. The mobile terminal at least includes a processor 401, and a memory 402 communicating with the processor 401.

The memory 402 is provided with at least one instruction which is executed by the processor 401 to perform the steps of the photographing method described above.

The processor 401 and the memory 402 are connected with each other by a bus. The bus can includes random quantity of interconnected buses and bridges. The bus connects the circuits of the at least one processor 401 and the memory 402. The bus can also connect elements like peripheral equipment, voltage stabilizer, or power management circuit, which is well-known to the public. The bus interface provides an interface between the bus and the transceiver. The transceiver may be one component, or a plurality of components, like a plurality of receivers and transmitters, for providing communication units for communicating with other units via the transfer medium. The data processed by the processor 401 can be transmitted by antenna via wireless network, and further the antenna will receive and transmit the data to the processor 401.

The processor 401 is in charge of managing the bus the normal processes. The processor can provide various functions, like timing, peripheral interfaces, voltage adjusting, power management, and other controlling functions. The memory 402 is used to store instructions and data for being provided to the processor 401.

A fifth embodiment relates to a computer readable storage medium storing a computer program. The program is executed to perform the embodiments described above.

The present disclosure uses the pressure sensing area beyond the displaying area to operate the photographing method, according to the posture of the mobile terminal. It is convenient for a user to photograph a photo by one hand, and the operating area will not affect the viewing area.

The technicians in the field can understand that all or part of the steps for realizing the above-mentioned embodiments can be accomplished by directing the relevant hardware through a program stored in a storage medium, including all or part of the steps used by several instructions for making a device (such as a single chip computer, a chip, etc.) or a processor to execute the methods described in all embodiments of the invention. The above-mentioned storage media include: U disk, mobile hard disk, Read-Only Memory (ROM), Random Access Memory (RAM), a disk or CD-ROM, which can store program codes.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A photographing method used in a mobile terminal including a side provided with a pressure sensing area, including the steps of:
detecting an operation status of a camera of the mobile terminal, when the camera is activated, obtaining a pressure value of the pressure sensing area;
comparing the pressure value to a first predetermined threshold value, when the pressure value achieves the first threshold value, controlling the camera to photograph.

2. The photographing method as described in claim 1, wherein after obtaining the pressure value of the pressure sensing area, comparing the pressure value to a second predetermined threshold value which is smaller than the first predetermined threshold value, when the pressure value achieves the second predetermined value, controlling an auto-focusing module of the camera to perform auto-focusing function.

3. The photographing method as described in claim 2 further including a step of providing a tactile feedback to the user for indicating whether the operation is correct or not, after obtaining the pressure value of the pressure sensing area, when the pressure value achieves the first or second predetermined threshold value.

4. The photographing method as described in claim 1 further including a step of detecting whether the mobile terminal is at a landscape status before obtaining the pressure value, when the mobile terminal is at the landscape status, obtaining the pressure value.

5. The photographing method as described in claim 4 further including a step of providing a reminder to the user to operate the camera at the side, after detecting that the mobile terminal is at landscape status.

6. The photographing method as described in claim 5, wherein the reminder includes an animation, a voice prompt, or a text prompt.

7. The photographing method as described in claim 1 further including the step of detecting a sliding operation on the side for performing adjusting a focal length of the camera.

8. The photographing method as described in claim 1, wherein the step of controlling the camera to photograph includes a step of photograph a photo when the mobile terminal is at photo mode, and a step of recording video when the mobile terminal is at video mode.

9. A mobile terminal, comprising:
at least one processor;
a memory communicating with the at least one processor, the memory being stored at least one instruction executed by the processor to perform the photographing method as described in claim 1.

10. A computer readable storage medium, storing a computer program for being executed by a processor for performing the photographing method as described in claim 1.
